(19) United States
(12) Patent Application Publication
(10) Pub. No.: US 2005/0250860 A1
(43) Pub. Date: Nov. 10, 2005

(54) Method and systrem for combating the formation of emulsions

(76) Inventors: David Eric Appleford, Essex (GB); Brian William Lane, Essex (GB)

Correspondence Address: SUMMA & ALLAN, P.A., 11610 NORTH COMMUNITY HOUSE ROAD, SUITE 200, CHARLOTTE, NC, 28277, US

(21) Appl. No.: 10/518,656

(22) PCT Filed: Jun. 27, 2003
(86) PCT No.: PCT/GB03/02763

§ 371 Date: Dec. 16, 2004

(30) Foreign Application Priority Data
Jun. 28, 2002 (GB) 02150621

(51) Int. Cl. B01D 17/04

(52) U.S. Cl. 516/135

(57) ABSTRACT

A system (1) for combating the formation of emulsions in production fluid has a control system which compares the volumetric flow rates of oil and water separated from production fluid in a separator vessel (16). When the ratio of the separated oil approaches that where emulsions are expected to form, a portion of the separated water is diverted into a fluid mixing device (10) and commingled with the production fluid being conveyed to the separator vessel (16) so that the commingled fluid has an oil to water ratio outside the range of oil to water ratios at which emulsions are likely to form. Alternatively, instead of comparing the volumetric flow rates of separated oil and water, the system can detect the presence of emulsions in the fluid in the separator vessel (16) by having a nucleonic level sensor in the vessel, the sensor being linked to the control system.

The present invention relates to a method and system for combating the formation of emulsions when oil and water are mixed, particularly in relation to the extraction of production fluid from a hydrocarbon reservoir.

One of the problems in relation to processing production fluid is the formation of emulsions when oil and water are mixed in a certain ratio. These emulsions, once formed, are very difficult to break down into their constituent oil and water parts.

Oil and water co-exist in hydrocarbon reservoirs as separate fluids. When produced from the reservoir these two fluids can form emulsions. This formation is aggravated by downhole pumps and choke valves, which act as mixers of the fluids.

Emulsions, once formed, are kinetically very stable. Natural surfactants such as wax, solids and especially asphaltene compounds have been found to be the main factors contributing to the stability of oil well emulsions.

Emulsions are undesirable as they adversely effect separation efficiently, and may cause cavitations in pumps. Emulsions may increase fluid viscosity, requiring higher power consumption for equipment, such as pumps, to work the fluid. Also, so-called emulsion slugs may occur in both liquid and gas pipelines (i.e. mainly liquid or gas with slugs of emulsions forming in the fluid). Emulsions may also interfere with the correct readings of some instruments, such as flow meters, temperature sensors and some separator level control sensors.

In general terms, the ratio of oil to water at which emulsions form is around 50% oil and 50% water by volume. The range will vary by a certain percentage either side of the 50:50 ratio, dependent upon many factors including temperature, oil type and the specific gravity of the oil.

Existing methods for overcoming the problem of emulsions are based on breaking down the emulsions once they have formed.

The normal method adopted is to inject a de-emulsifying chemical (surfactant) into the production stream, as near to the wellhead or wellheads in an oil/gas field as possible. No two emulsion problems are the same, as such, laboratory analysis of the production fluid is required to determine the best de-emulsifying chemical fluid for each field application.

Other methods used include gravity separation in large vessels, with long residence times, coalescence, and using electro-treaters. Gravity separation is more effective at higher temperatures (66° C. to 149° C. (150° F. to 300° F.)). Coalescence speeds up the breakdown of emulsions by increasing the available surface area of separation of the emulsion, usually by the introduction of specialist separator internals including additional surfaces specifically incorporated to enhance the breakdown of the emulsions. Electro-treaters variously use electric or radio fields to “pull” the oil and water phases apart.

With the exception of the de-emulsifying chemical injection method, all other methods are best suited to onshore or “topside” applications, and all these other methods are expensive to install and operate.

In the case of de-emulsifying chemical injection method, this has the added expense of requiring a chemical injection supply line from the host facility to near the wellhead(s), which may be several tens of kilometres away.

An object of the present invention to provide a method and system which overcome at least some of the above-mentioned disadvantages.

According to one aspect of the present invention, there is provided a method for combating the formation of emulsions in production fluid, comprising the steps of:
detecting either (a) a ratio of oil to water in the production fluid which is liable to lead to emulsion formation, or (b) the presence of emulsions in the production fluid; and
commingling fluid with the production fluid so that the commingled fluid has an oil to water ratio outside a range of oil to water ratios at which emulsions are liable to form.

The method combats/avoids the formation of emulsions at an economical cost and accordingly allows processing and pressure boosting equipment for production fluid processing, and the associated instrumentation to perform satisfactorily.

The method is of benefit to seabed processing and pressure boosting systems, as well as processing and pressure boosting systems onshore, or on a fixed or floating rig.

The detecting step may comprise the steps of measuring the ratio of oil to water in a production fluid, and detecting if the oil to water ratio is inside the range of oil to water ratios at which emulsions are formed.

Alternatively, the detecting step may comprise using a nucleonic level sensor or some other appropriate sensor installed in a suitable vessel to detect the formation of emulsions in the production fluid.

The method may include the additional step of separating a fluid from the production fluid, and the commingling step may comprise commingling at least a portion of said fluid separated from the production fluid with the production fluid before the production fluid is detected for emulsions. The fluid separated and commingled with the production fluid may comprise oil or water. The steps of measuring the ratio of oil to water in a production fluid and detecting if the oil to water ratio is inside the range of oil to water ratios at which emulsions are formed may comprise comparing the volumetric flowrate of oil separated from the production fluid with the volumetric flowrate of water separated from the production fluid.

The commingling step may take place at or near at least one wellhead. The separating step may take place at a host facility or at or near at least one wellhead. If the separating step takes place at or near at least one wellhead then a fluid supply line for supplying fluid for commingling from the host facility is not required since a separated fluid is used for commingling. The separating step may take place in a retrievable module for use with a modular seabed processing system. The commingling step may take place in a retrievable module for use with a modular seabed processing system. Preferably, the retrievable module is located near at least one wellhead. Both the separating and commingling steps may take place in the retrievable module. Where the separating/commingling step(s) takes place near at least one wellhead, then this is preferably taken to mean that it takes place substantially closer to the at least one wellhead than to the host facility arranged to receive production fluid from the at least one wellhead.

The separating step requires separating means such as a separator vessel. Such a vessel is sized so that the amount of separated fluid added to the production fluid to at least substantially avoid emulsion formation enables satisfactory separation levels to be maintained in the vessel.

According to another aspect of the present invention, there is provided a system for combating the formation of emulsions, comprising:
means for detecting either (a) a ratio of oil to water in the production fluid which is liable to lead to emulsion formation, or (b) the presence of emulsions in the production fluid; and
commingling means for commingling fluid with the production fluid so that the commingled fluid has an oil to water ratio outside the range of oil to water ratios at which emulsions are liable to form.

The system may comprise components required for any of the method steps referred to above.

The invention will now be described, by way of example, with reference to the accompanying drawings, in which:—

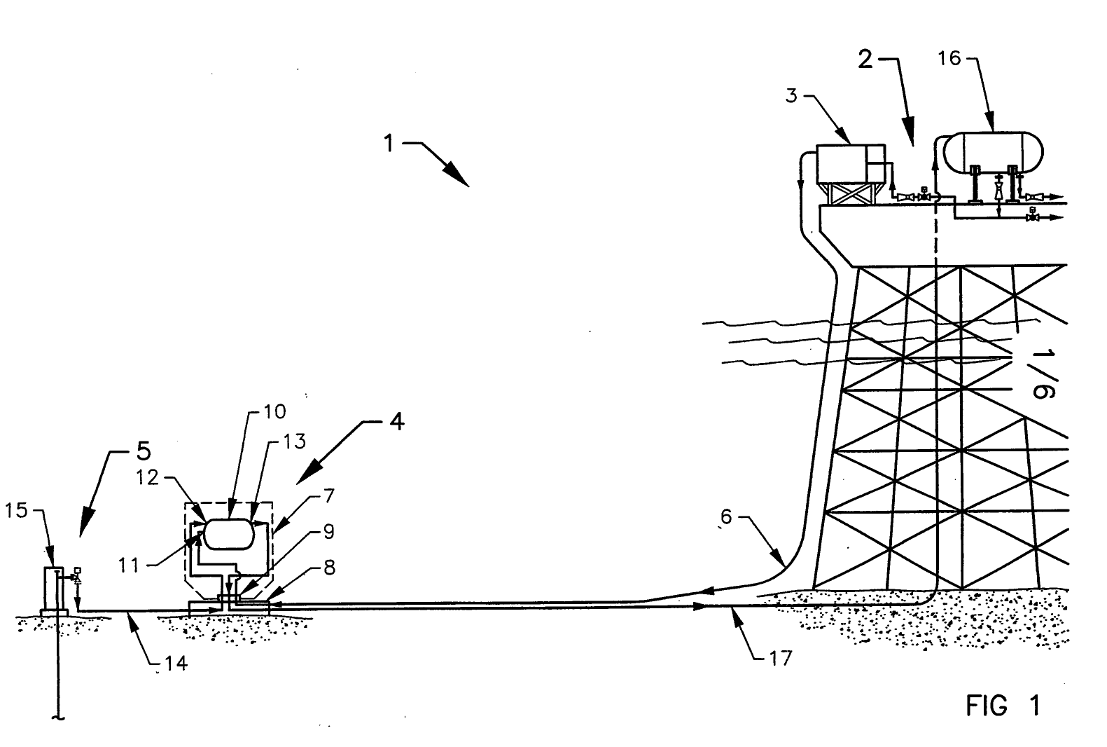

FIG. 1 schematically shows a system in accordance with a first embodiment of the present invention;

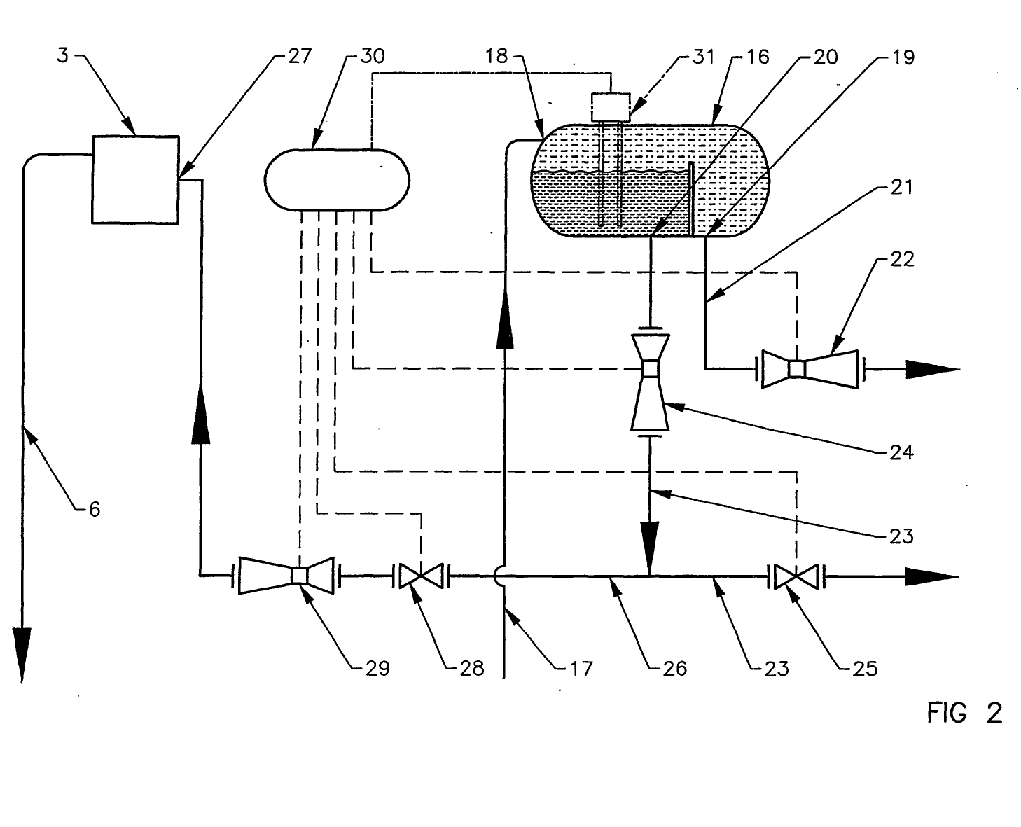

FIG. 2 is a detail of FIG. 1;

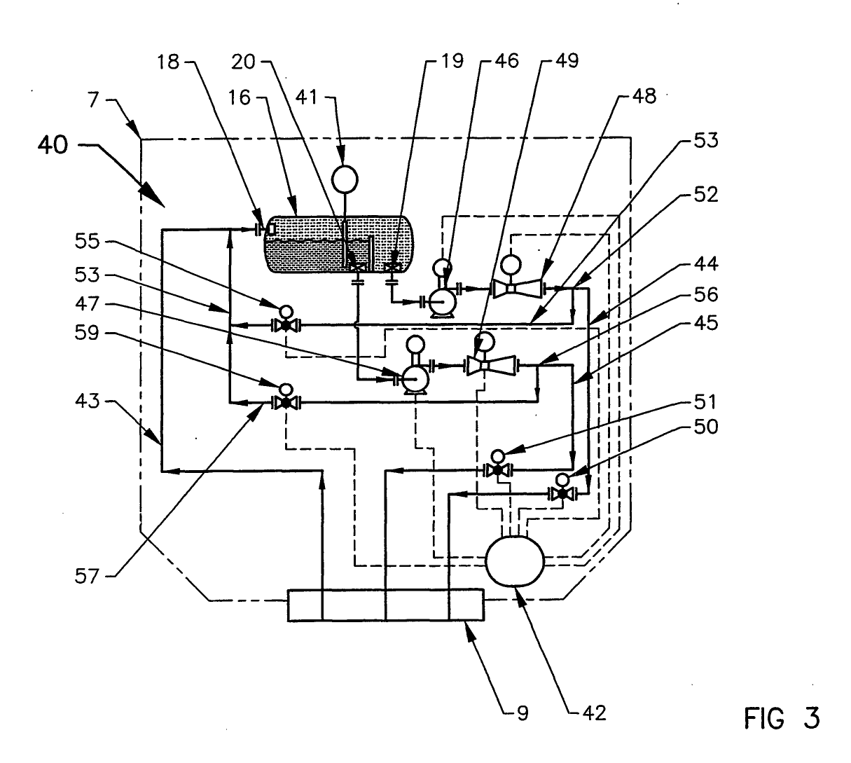

FIG. 3 is a schematic diagram of a retrievable module containing a system in accordance with a second embodiment of the present invention;

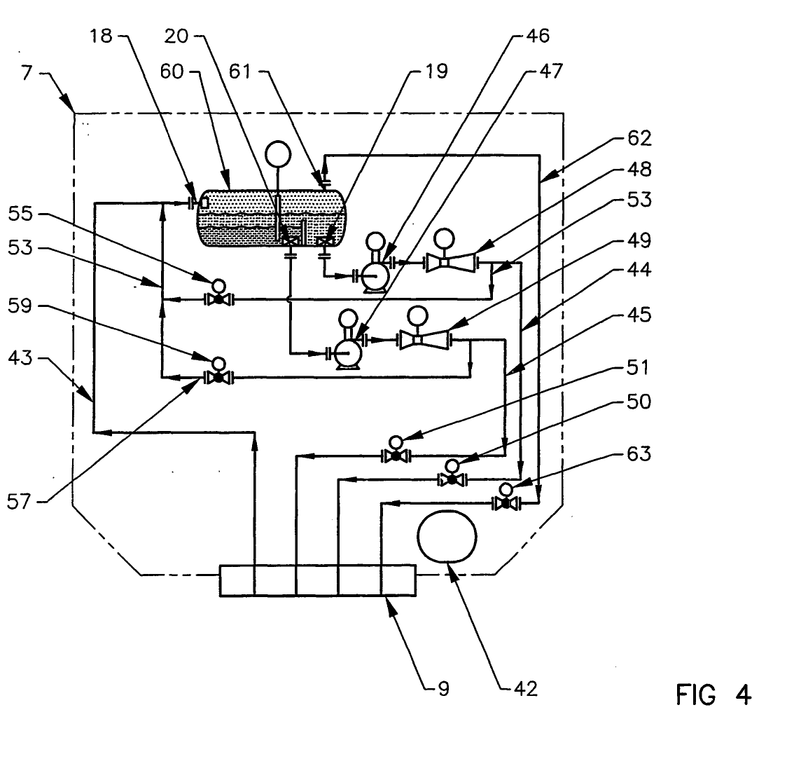

FIG. 4 is a modification of FIG. 3;

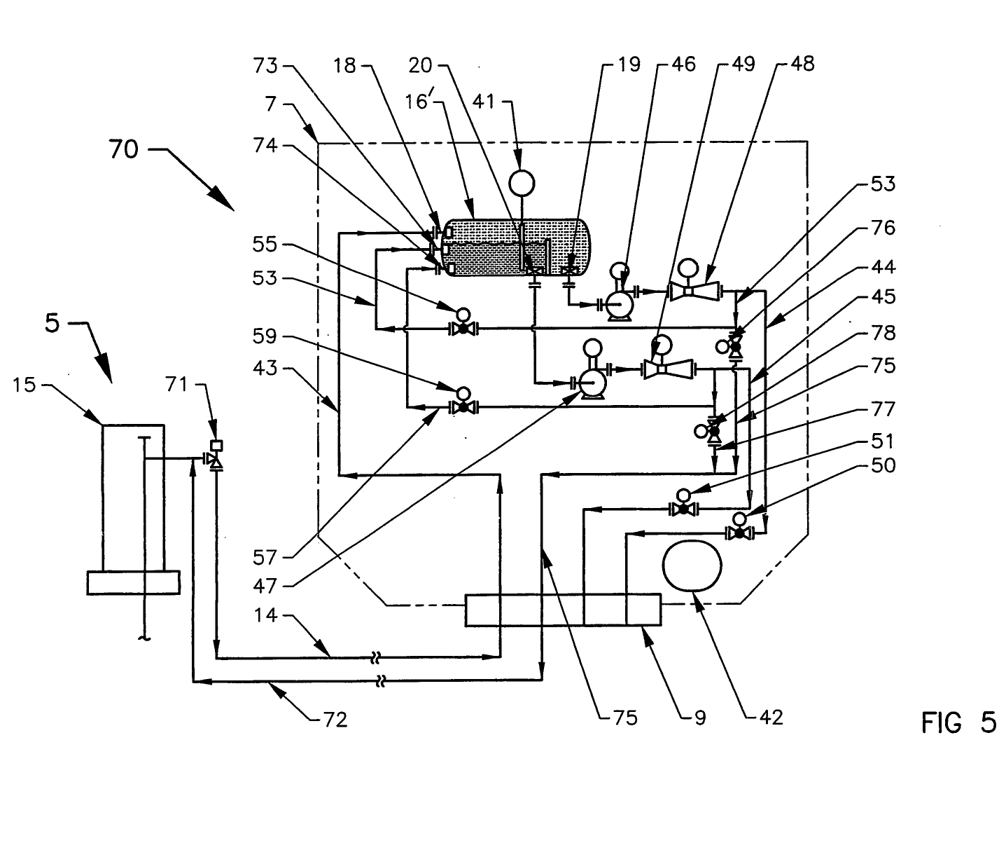

FIG. 5 is a schematic diagram of a system, incorporating a retrievable module, in accordance with a third embodiment of the present invention; and

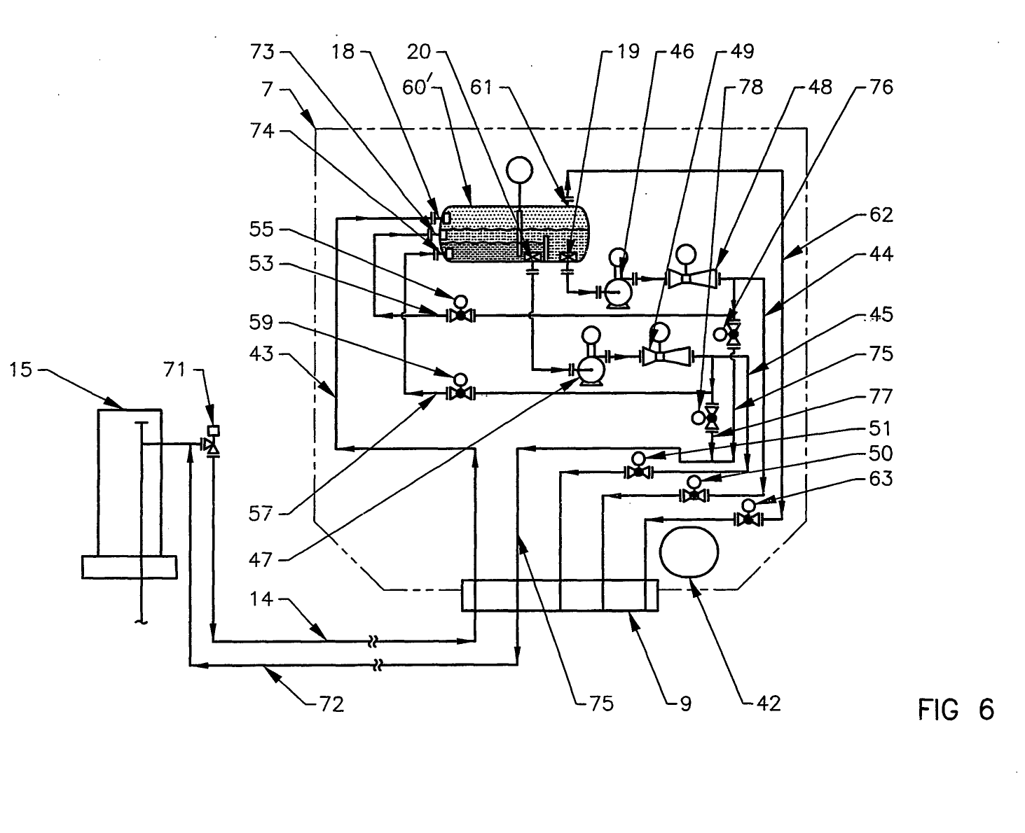

FIG. 6 is a modification of FIG. 5.

In the following description like numerals are used to designate like parts which are generally only described in detail once.

Referring to FIGS. 1 and 2 of the accompanying drawings, the system 1 has a host facility 2, which may be, for example, onshore or on a fixed or floating rig. The host facility 2 has a water treatment facility 3 which is connected to a remote seabed facility 4 near a wellhead 5 by a treated water supply pipeline 6.

The seabed facility 4 comprises a retrievable module 7 connected to a base structure 8 on a seabed by a multi-ported fluid connector 9 for enabling isolation of the module 7 from the base structure 8. The module 7 may be of the general type forming part of a modular system for subsea use designed by Alpha Thames Limited of Essex, United Kingdom, and referred to as AlphaPRIME.

The module 7 contains a fluid mixing device 10 which has two fluid inlets 11,12 and a fluid outlet 13. The first fluid inlet 11 is connected to the treated water supply pipeline 6, the second fluid inlet 12 is connected to a pipeline 14 from a production wellhead Christmas tree 15 at the wellhead 5 and the fluid outlet 13 from the fluid mixing device 10 is connected to a two-phase separator vessel 16 on the host facility 2 by a production fluid pipeline 17. The connections between the fluid inlets 11,12 and outlet 13 and their associated pipelines 6,14,17 are all via the multi-ported fluid connector 9.

The separator vessel 16 has an inlet 18 connected to the production fluid pipeline 17 and two outlets 19,20. The first outlet 19 is connected to an oil conduit 21 which has a venturi-flowmeter 22, and the second outlet 20 is connected to a water conduit 23 which has a venturi-flowmeter 24 and a water flow control valve 25 downstream of the venturi-flowmeter 24. A water supply conduit 26 connects a water inlet 27 of the water treatment facility 3 to the water conduit 23 between the venturi-flowmeter 24 and the flow control valve 25, and the water supply conduit 26 has a flow control valve 28 and a venturi-flowmeter 29 downstream of the flow control valve 28. The venturi-flowmeters 22,24,29 are linked to the control valves 25,28 by a control system 30 which is arranged to control the valves 25,28 in response to receiving flow readings from the venturi-flowmeters 22,24,29.

Any pumps required for the system 1 have been omitted for the purposes of clarity.

The operation of the system will now be described.

Production fluid or a production stream from the wellhead 5 is conveyed via the mixing device 10 to the separator vessel 16 on the host facility 2 where it is separated into oil and water. The control system 30 compares the volumetric flow rate of the separated oil measured by the oil venturi-flowmeter 22 with the volumetric flow rate of the separated water measured by the water venturi-flowmeter 24. When the ratio of the separated oil and water flow rates approaches that where emulsions are expected to form, the water supply conduit flow control valve 28 is opened sufficiently, and the water flow control valve 25 closed sufficiently, so that a portion of the separated water is recirculated into the fluid mixing device 10 in the module 7 via the water supply conduit 26, the water treatment facility 3 where it is treated, and the treated water supply pipeline 6. At the fluid mixing device 10 the recirculated water is mixed with the production fluid, and the flow control valves 25 and 28 are adjusted sufficiently at the host facility 2 to add enough water to the production fluid at the fluid mixing device 10 so as to achieve an oil/water ratio so that the formation of emulsions is at least substantially avoided. The mixture of commingled production fluid and added water is then conveyed from the fluid mixing device 10 by the production fluid pipeline 17 to the host facility 2 and the pipeline 17 needs to have a large enough diameter to take the mixture of production fluid and added water. The separator vessel 16 receiving the production fluid and added water is designed so that the amount of water added to the production fluid to avoid emulsion formation enables satisfactory separation levels to be maintained in the vessel 16.

The control system 30 compares the volumetric flow rates of the oil and water separated from the mixture of production fluid and recirculated water and the control system 30 can adjust the water supply conduit flow control valve 28 to maintain the required oil/water ratio or range of ratios. The separator vessel 16 at the host facility 2 needs to be of a sufficient capacity to accommodate for the recirculated water added to the production fluid.

In a modification to the system, the two-phase separator vessel 16 has a nucleonic level sensor 31 (shown in chain dot in FIG. 2) linked to the control system 30 and which uses an array comprising a plurality of radioactive sources e.g. gamma ray sources and a corresponding confronting array of sensors spaced from the sources. The degree of absorption effected by the fluid between each source and its corresponding sensor can be analysed to indicate the density of the fluid adjacent to that sensor which in turn indicates whether the fluid is emulsion, oil, water, gas, sand, etc. Such a sensor is the Tracerco Profiler produced by Synetix of Billingham, Cleveland, United Kingdom. When the Tracerco Profiler is used in a three-phase separator it enables the levels of different production fluids (i.e. oil, water and gas), sand, emulsions between the oil and sand, and foam which may form at the oivgas interface, to be identified, this information being primarily used to maintain the desired fluid levels within the separator.

The nucleonic level sensor 31 continually or periodically sends a signal to the control system 30 and when emulsions are first detected, a signal is sent via the control system 30 to adjust the flow control valves 25 and 28, so that a sufficient portion of the separated water is recirculated into the fluid mixing device 10 in the module 7 in order to achieve an oil/water ratio at which the formation of emulsions is at least substantially avoided.

FIG. 3 illustrates a second embodiment of the invention whereby the system 40 is within the retrievable module 7 and the fluid mixing device 10 in the module has been replaced by a twophase separator vessel 16 which is no longer required at the host facility (not shown). The separator vessel 16 has a level sensor 41 for detecting the position of the interface between the oil and water in the vessel 16 linked to a module control system 42.

The fluid inlet 18 of the two-phase separator vessel 16 is connected by a production fluid conduit 43 to a pipeline (not shown) from a production fluid wellhead Christmas tree via the multi-ported fluid connector 9. The first outlet 19 of the separator vessel 16 is connected by an oil conduit 44 to a dedicated oil pipeline (not shown) to the host facility via the multi-ported fluid connector 9. The second outlet 20 of the separator vessel 16 is connected by a water conduit 45 to a water pipeline (not shown) via the multi-ported fluid connector 9. The water pipeline is routed either to the host facility or to a dedicated water disposal well.

Both the oil conduit 44 and the water conduit 45 each have a liquid booster pump 46,47, a venturi-flowmeter 48,49 downstream of the pump 46,47, and a flow control valve 50,51 downstream of the venturi-flowmeter 48,49. Between the oil venturi-flowmeter 48 and the oil conduit flow control valve 50 is a junction 52 in the oil conduit 44 from which a return line 53 connects the oil conduit 44 to the production fluid conduit 43 via a flow control valve 55. Also, between the water venturi-flowmeter 49 and the water conduit flow control valve 51 is a junction 56 in the water conduit 45 from which a return line 57 connects the water conduit 45 via a flow control valve 59 to the oil return line 53 downstream of the oil return line's flow control valve 55.

The venturi-flowmeters 48,49 are linked to the flow control valves 50,51,55,59 by the module control system 42 which is arranged to control the flow control valves 50,51,55,59 in response to receiving flow readings from the venturi-flowmeters 48,49.

In use, production fluid enters the separator vessel 16 and is separated into oil and water which are then conveyed from the module 7 via the oil conduit 44 and the water conduit 45 respectively.

In the event that the level sensor 41 detects a drop in the oil level in the separator vessel 16, the control system 42 causes the oil conduit flow control valve 50 and the return line flow control valve 55 to be adjusted to recirculate some of the separated oil via the oil return line 53. Once the oil level in the separator vessel 16 is satisfactorily re-established, the flow control valves 50 and 55 are adjusted to maintain this level.

The control system 42 also compares the volumetric flow rate of the separated oil measured by the oil venturi-flowmeter 48 with the flow rate of the separated water measured by the water venturi-flowmeter 49. When the ratio of the separated oil and water flow rates approaches that at which emulsions are expected to form, the oil conduit flow control valve 50 and the oil return flow control valve 55 are adjusted so that a sufficient portion of the separated oil is recirculated via the oil return line 53 in order to achieve an oilvwater ratio where the formabon of emulsions are avoided.

In the same way, a portion of the separated water may be recirculated instead of the oil in order to maintain the water level in the separator and to adjust the oil/water ratio to prevent the formation of emulsions, the water being recirculated via the water return line 57.

FIG. 4 illustrates a modification of the retrievable module 7 in which the two-phase separator vessel 16 has been replaced by a three-phase separator vessel 60. The vessel has a third outlet 61 which is connected by a gas conduit 62 to a dedicated gas pipeline (not shown) to the host facility via the multi-ported fluid connector 9, and the gas conduit 62 has a pressure control valve 63 controlled by the module control system 42. Connections between the module control system 42 and the pumps, venturi-flowmeters and valves have been omitted for clarity.

A system 70 for recirculating liquid back to the wellhead 5 is illustrated in FIG. 5 and is the same as the embodiment shown in FIG. 3 except where described otherwise.

The wellhead pipeline 14 to the module 7 has a choke valve 71 at the wellhead production Christmas tree 15 and a liquid recirculation pipeline 72 from the retrievable module 7 is connected to the wellhead pipeline 14 upstream of the choke valve 71. Inside the module, the two phase separator 16′ is adapted to have two further inlets 73,74 in addition to the first inlet 18, the oil return line 53 being connected to the second inlet 73 and the water return line 57 being connected to the third inlet 74.

The liquid recirculation pipeline 72 is connected to one end of a liquid conduit 75 in the module 7 by the multi-ported fluid connector 9. The other end of the liquid conduit 75 is connected to the oil return line 53, upstream of its flow control valve 55. The liquid conduit 75 has a flow control valve 76 linked to the module control system 42, and downstream of this valve 76, a branch liquid conduit 77 connects the water return line 57, upstream of its flow control valve 59, to the liquid conduit 75, and the branch liquid conduit 77 also has a flow control valve 78 which is linked to the control system 42. Connections between the module control system 42 and the pumps, venturi-flowmeters and valves have been omitted for clarity.

In normal use, flow control valves 76 and 78 are closed. When the control system 42 detects a ratio of the separated oil and water flow rates which approaches that at which emulsions are expected to form, the liquid conduit flow control valve 76 is adjusted so that a sufficient portion of the separated oil is recirculated via the liquid recirculation pipeline 72. The separated oil is then commingled with the production fluid upstream of the Christmas tree choke valve 71 and enables an oil/water ratio to be achieved at which the formation of emulsions is at least substantially avoided.

In the same way, a portion of the separated water may be recirculated instead of the oil to commingle with the production fluid at the Christmas tree 15 in order to adjust the oil/water ratio to at least substantially prevent the formation of emulsions. To enable this to happen, the branch liquid conduit flow control valve 78 is adjusted so that a sufficient portion of the separated water is recirculated.

Thus, only one liquid is recirculated upstream of the choke valve 71 at any one time.

A modification of the system is shown in FIG. 6 in which the two-phase separator vessel 16′ has been replaced by a three-phase separator vessel 60′ which has a third outlet 61 which is connected by a gas conduit 62 to a dedicated gas pipeline (not shown) like that shown in FIG. 4.

In all the above embodiments and modifications, the pumps may be driven by single speed or variable speed motors.

Whilst particular embodiments have been described, it will be understood that various modifications may be made without departing from the scope of the invention. For example, for the first embodiment and its above described modification, the system 1 may be arranged to enable a portion of the separated oil instead of a portion of the separated water to be recirculated in a similar manner to prevent the formation of emulsions. This would require a conduit/pipeline for conveying separated oil to the fluid mixing device 10 and a control valve for controlling the flow of separated oil to be recirculated. Also, the two-phase separator vessel 16 of the first embodiment and its above described modification may be replaced by a three-phase separator vessel.

Recirculated liquid from the separator vessel 16,16′,60,60′ may be injected into the production fluid downhole in one or more of the wells.

The nucleonic level sensor may be used in the second and third embodiments and their above described modifications.

1. A method for combating the formation of emulsions in production fluid, comprising the steps of:
commingling fluid with the production fluid; and
detecting either (a) a ratio of around 50% oil and 50% water by volume in the production fluid at which emulsions form, or (b) the presence of emulsions in the production fluid;
wherein the commingled fluid has an oil to water ratio outside a range of oil to water ratios at which emulsions are liable to form.

2. The method as claimed in claim 1, wherein the detecting step further comprises the steps of:
measuring the ratio of oil to water in a production fluid; and
detecting if the oil to water ratio is inside the range of oil to water ratios at which emulsions are formed.

3. The method as claimed in claim 2, wherein the measuring step and subsequent detecting step further comprise comparing the volumetric flowrate of oil separated from the production fluid with the volumetric flowrate of water separated from the production fluid.

4. The method as claimed in claim 1, wherein the detecting step comprises detecting the formation of emulsions in the production fluid using a nucleonic level sensor or some other appropriate sensor installed in a suitable vessel.

5. The method as claimed in claim 1, including the additional step of adjusting the amount of fluid to be commingled with the production fluid in response to the detecting step to maintain that the commingled fluid has an oil to water ratio outside a range of oil to water ratios at which emulsions are liable to form.

6. The method as claimed in claim 1, including the additional step of separating a fluid from the production fluid; and
wherein the commingling step further comprises commingling at least a portion of said fluid separated from the production fluid with the production fluid before the production fluid is detected for emulsions.

7. The method as claimed in claim 6, wherein oil comprises the fluid separated and commingled with the production fluid.

8. The method as claimed in claim 6, wherein the separating step further comprises the step of separating a fluid from the production fluid place at a host facility or about at least one wellhead.

9. The method as claimed in claim 6, wherein the separating step further comprises the step of separating a fluid from the production fluid in a retrievable module for use with a modular seabed processing system.

10. The method as claimed in claim 6, wherein both the separating and commingling steps further comprise the steps of separating a fluid from the production fluid and commingling at least a portion of said fluid separated from the production fluid with the production fluid before the production fluid is detected for emulsions in a retrievable module for use with a modular seabed processing system.

11. The method as claimed in claim 1, wherein the commingling step further comprises commingling fluid with the production fluid place in a retrievable module for use with a modular seabed processing system.

12. The method as claimed in claim 1, wherein the commingling step further comprises commingling fluid with the production fluid about at least one wellhead.

13. A system for combating the formation of emulsions, comprising:
commingling means for commingling fluid with the production fluid so that the commingled fluid has an oil to water ratio outside the range of oil to water ratios at which emulsions are likely to form; and
means for detecting either (a) a ratio of around 50% oil and 50% water by volume in the production fluid at which emulsions form, or (b) the presence of emulsions in the production fluid.

14. The method as claimed in claim 6, wherein water comprises the fluid separated and commingled with the production fluid.
